(19) United States
(12) Patent Application Publication
(10) Pub. No.: US 2001/0017710 A1
(43) Pub. Date: Aug. 30, 2001

(54) Multifunctional printing system

(76) Inventors: Takashi Sugitou, Kashihara-shi (JP); Hirohito Morioka, Kitakatsuragi-gun (JP); Mariko Arai, Kashihara-shi (JP); Masaaki Kawakami, Yamatokoriyama-shi (JP); Koji Tsukamoto, Yamatokoriyama-shi (JP)

Correspondence Address: Dike, Bronstein, Robert & Cushman, LLP, 130 Water Street, Boston, MA, 02109, US

(21) Appl. No.: 09/781,642

(22) Filed: Feb. 12, 2001

(30) Foreign Application Priority Data
Feb. 24, 2000 (JP) 2000-047669

(51) Int. Cl. B41B 1/00

(52) U.S. Cl. 358/1.14

(57) ABSTRACT

A multifunctional printing system wherein image information captured by a scanner etc., can be printed as multiple sets of copies by a printer and which is configured so that the printing operation can be stopped only at intervals from one set of copies to the next or every certain number of printouts, includes: a computing portion for calculating the time at which an interrupt can be made next, based on the designated number of print sets, the current state of printing, the information as to whether an interrupt is permissible; and a display portion for displaying the permissible interrupt time calculated by the computing portion.

### BACKGROUND OF THE INVENTION

(1) Field of the Invention

The present invention relates to a multifunctional printer capable of displaying the time at which an interrupt job can be started.

(2) Description of the Prior Art

Conventionally, there have been known printing systems which present the time of engagement of a designated printing job or the finish time of a print job. Japanese Patent Application Laid-Open Hei 8 No.212021 can be mentioned as an example. This disclosure offers a printing system which presents the expected finish time of a designated print job to the user who designates that operation. This system is useful in systems capable of handling printing jobs involving many printouts and a multiple number of print reservations. In this system, since the finish time of the printing job is displayed, the user will not be kept waiting when he/she comes to pick up the printouts.

FIG. 1 shows a flowchart of the prior art. The operation of the program starts at Step 201 and waits at Step 202 until a print request is made. When a print request is made, the operation goes to Step 203, where the finish time is calculated from the designated number of copies in the current printing operation. Based on the result calculated at Step 203, the finish time is displayed at Step 204. This sequence of calculation and display is repeated until the printing ends(Step 205).

In this way, the prior art system is carried out based on the assumption that the latest user's print request is added to the end of the current printing job or the end of the queue of print requests reserved.

However, when a new user's print request is made as an interrupt job and this print job should be started not at the end of the queue of the currently reserved print requests but at a certain appropriate interval, it was impossible for the prior art to make a prediction about the user's request, i.e., how long it will take from the start of printing, when the user's designated print job starts or when the user's designated print job ends.

If the finish time of all the reserved print jobs is known, there is no benefit for the user who has made a print reservation by making an interrupt. That is, the system cannot tell the user at what timing an interrupt can be made next.

### SUMMARY OF THE INVENTION

In view of the above problems, it is therefore an object of the present invention to provide a multifunctional printing system which can offer advantage to the user who requests interrupt printing, by enabling the permissible interrupt time, the time length up to the permissible interrupt time or the like, to be displayed in a system configuration which allows an interrupt to be made during the current printing operation without the necessity of keeping the user waiting for the end of the printing operation involving a large number of prints but only allows an interrupt to be made at the interval between jobs or at the intervals between certain periods within one job.

In order to achieve the above object, the present invention is configured as follows:

In accordance with the first aspect of the present invention, a multifunctional printing system wherein image information captured through an image information pickup means can be printed as multiple sets of copies by a printing means and which is configured so that the printing operation can be stopped only at intervals from one set of copies to the next or every certain number of printouts, includes:

a computing means for calculating the time at which an interrupt can be made next, based on the designated number of print sets, the current state of printing, the information as to whether an interrupt is permissible; and

a display means for displaying the permissible interrupt time calculated by the computing means.

Here, the image information captured by the pickup means includes not only image information such as photographs captured by a scanner etc., but also text information and the like input from a word processor.

In accordance with the second aspect of the present invention, a multifunctional printing system wherein image information captured through an image information pickup means can be printed as multiple sets of copies by a printing means and which is configured so that the printing operation can be stopped only at intervals from one set of copies to the next or every certain number of printouts and so that the printing operation needs to be stopped in order to allow an interrupt job, includes:

a computing means for calculating the permissible termination time which allows for an interrupt job, based on the designated number of print sets, the current state of printing, the information as to whether an interrupt is permissible; and

a display means for displaying the permissible termination time calculated by the computing means.

In accordance with the third aspect of the present invention, the multifunctional printing system having the above first feature is characterized in that the computing means has the function of calculating the finish time of the requested interrupt job instead of calculating the permissible interrupt time or permissible termination time, and the display means has the function of displaying the finish time of the interrupt job calculated by the computing means.

In accordance with the fourth aspect of the present invention, the multifunctional printing system having the above second feature is characterized in that the computing means has the function of calculating the finish time of the requested interrupt job instead of calculating the permissible interrupt time or permissible termination time, and the display means has the function of displaying the finish time of the interrupt job calculated by the computing means.

In accordance with the fifth aspect of the present invention, the multifunctional printing system having the above first feature is characterized in that the computing means, instead of having the function of calculating the permissible interrupt time, the permissible termination time or the finish time of the interrupt job, has the function of calculating the time length corresponding to any of these, and the display means has the function of displaying the time length calculated by the computing means.

In accordance with the sixth aspect of the present invention, the multifunctional printing system having the above second feature is characterized in that the computing means, instead of having the function of calculating the permissible interrupt time, the permissible termination time or the finish time of the interrupt job, has the function of calculating the time length corresponding to any of these, and the display means has the function of displaying the time length calculated by the computing means. Simply, according to the above fifth and sixth features, the printing system displays the required remaining time, instead of displaying the time of an event.

In accordance with the seventh aspect of the present invention, the multifunctional printing system having any of the above first through sixth features is characterized in that the display means displays the time or time length in response to the operation of a dedicated key which allows for input of a display request.

In accordance with the eighth aspect of the present invention, the multifunctional printing system having any of the above first through sixth features is characterized in that the display means displays the time or time length when the key for requesting an interrupt is operated.

In accordance with the ninth aspect of the present invention, the multifunctional printing system having any of the above first through sixth features is characterized in that a voice generating means for informing the time or the time length via voice is provided instead of the display means.

### BRIEF DESCRIPTION OF THE DRAWINGS

FIG. 1 is a flowchart showing the operation flow of a printing system according to the prior art;

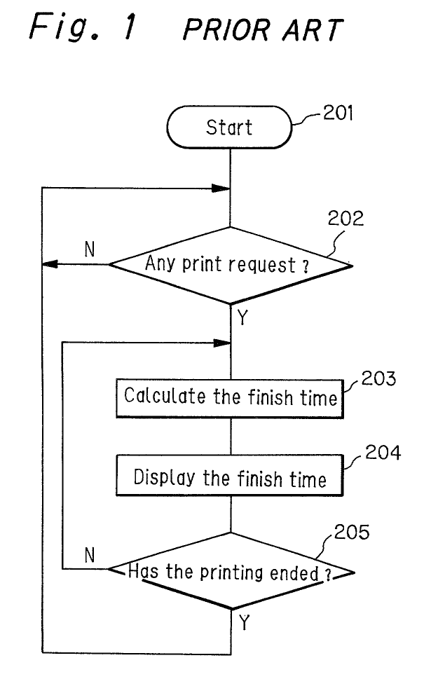

FIG. 2 is a flowchart showing the operation flow of a printing system according to the present invention;

FIG. 3 is a schematic diagram showing the configuration of the printing system according to the present invention;

FIG. 4 is an illustrative example showing permissible interrupt timing in a printing system which stops its operation every certain number of printouts;

FIG. 5 is an illustrative example showing permissible interrupt timing in a printing system which stops its operation at every job interval; and

FIG. 6 is a diagram for illustrating the display time of the printing system of the present invention, for a pre-feed printing system configuration.

### DESCRIPTION OF THE PREFERRED EMBODIMENTS

The embodiments of the present invention will hereinafter be described in detail with reference to the accompanying drawings.

(Embodiment 1)

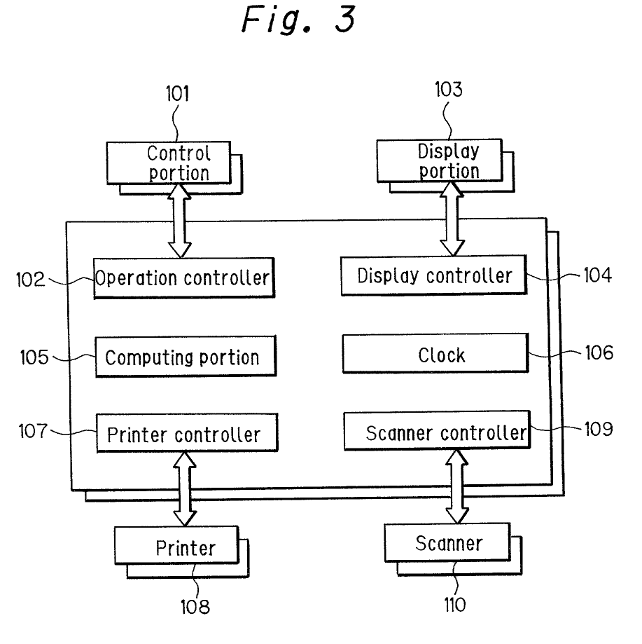

FIG. 3 shows an example configuration of a multifunctional printing system according to the present embodiment. In this example, description is made assuming the apparatus is a multifunctional electronic copier(image forming apparatus).

Designated at 101 is a control portion, where keys for controlling the copier are arranged. For example, this control portion has various keys for copy start, print number setting, interrupt reservation and the like. These keys are operated so as to designate control information such as the number of print sets, interrupt requests etc., which in turn are transferred to the operation controller designated at 102. Operation controller 102 analyzes the information input through control portion 101 and sends the information to necessary controllers. Designated at 103 is a display portion(display means) for displaying the operation status of the copier, including the designated number of print sets, the interrupt state, the error state and the like. Reference numeral 104 designates a display controller for converting the display information transferred from other controllers into a signal which can be displayed on display portion 103. Reference numeral 105 designates a computing portion(computing means) for computing the time(point of time) at which an interrupt can next be made, based on the designated number of print sets, the current state of printing, and information as to whether an interrupt is permissible. Reference numeral 106 designates a clock for indicating the present time. Reference numeral 107 designates a printer controller for controlling a printer(printing means) 108. Reference numeral 109 is a scanner controller for controlling a scanner(image information capturing means) 110.

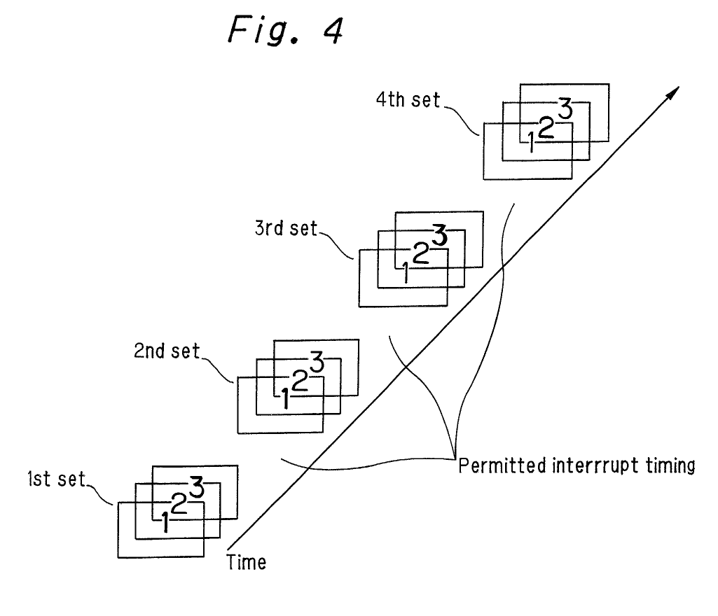

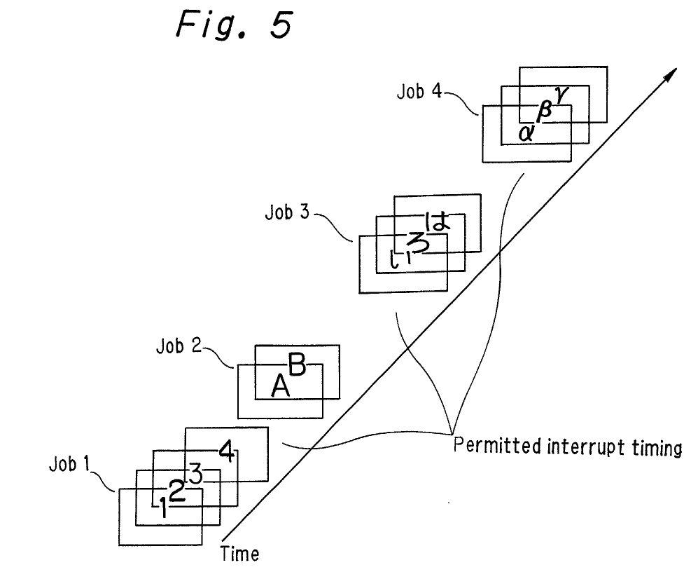

FIGS. 4 and 5 are illustrative diagrams showing the timing at which an interrupt can be made. Of these, FIG. 4 shows a system where an interrupt can only be made at the interval from one set to the next as illustrated when three documents are copied as four sets with in total twelve copies being made. FIG. 5 shows a system where an interrupt can only be made at the interval from one job to the next as illustrated.

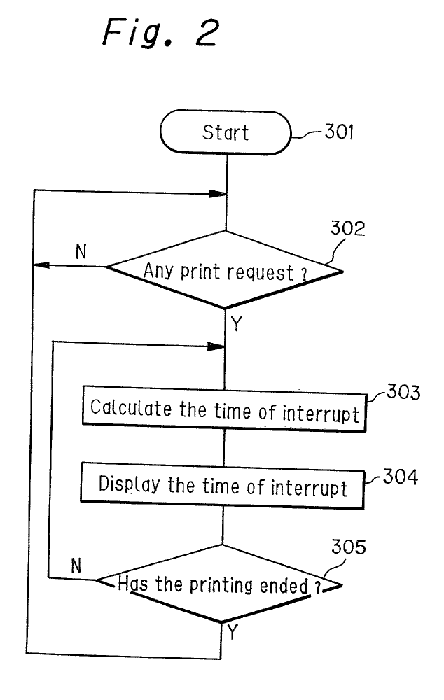

Next, the operation of the above printing system will be described with reference to the flowchart shown in FIG. 2 and the block diagram shown in FIG. 3. Here, for example, the system is assumed to be that in which an interrupt can only be made at the interval from one set to the next.

At Step 301 in FIG. 2, the program starts and waits at Step 302 until a print request is made. When a print request is made by the user through control portion 101, operation controller 102 issues the print request information to computing portion 105 so that the operation goes to Step 303.

In the process of computing the time of interrupt at Step 303, computing portion 105 calculates ‘time at which an interrupt can be made next’ based on the print request information from operation controller 102, the present time from clock 106 and the information as to the current print status from printer controller 107.

For example, a 20 CPM copier can perform printing at one copy every three seconds. Suppose the current time is 01:02:00. When four sets of three documents, in total 12 copies, need to be made as shown in FIG. 4, an interrupt can be made after three copies have been made. Therefore, the first permissible interrupt time is computed to be at a time nine seconds later, ‘01:02:09’, and the result is transferred to display controller 104 so that ‘01:02:09’ is displayed on display portion 103(Step 304). If printing has not ended, the operation returns to Step 303 for the process of computing the interrupt start time and the above computing sequence is repeated.

Now, when four copies have been printed and the operation returns to Step 303 for re-computation, the next permissible interrupt timing is at a time after six copies have been printed, so that ‘01:02:18’ is displayed on display portion 103. This calculation and display is repeated until the end of printing at Step 305.

The above description was made referring to a system example shown in FIG. 4 where an interrupt can only be made at the interval from one set of copies to the next. The operation flow is the same as in a system shown in FIG. 5 where an interrupt can only be made at the interval from one job to the next. FIG. 5 shows a case where job 1 of four printouts, job 2 of two printouts, job 3 of three printouts and job 4 of three printouts are sequentially made. When the current time is the same as above at 01:02:00 and one copy needs three seconds, the permissible interrupt timing calculated by the process of computing the time of interrupt at Step 303 corresponds to the end of job 1 or the time after four copies have been completed, so that ‘01:02:12’ is displayed on display portion 103. If the current state is that seven copies have been printed out, an interrupt can be allowed after the end of job 3 or when nine copies have been printed out so that ‘01:02:27’ is displayed.

(Embodiment 2)

For a system which needs to terminate the current job for an interrupt process, computing portion 105 calculates the time at which the current job can be terminated for the next interrupt, based on the designated number of print sets, the current status of printing and the information as to whether an interrupt is permissible, and the calculated timing of termination is displayed on display portion 103. Here, the timing of termination is a timing calculated by adding ‘time required for paper discharge’ to the ‘permissible interrupt timing’. This time is displayed on display portion 103 so as to realize the timing of interrupt.

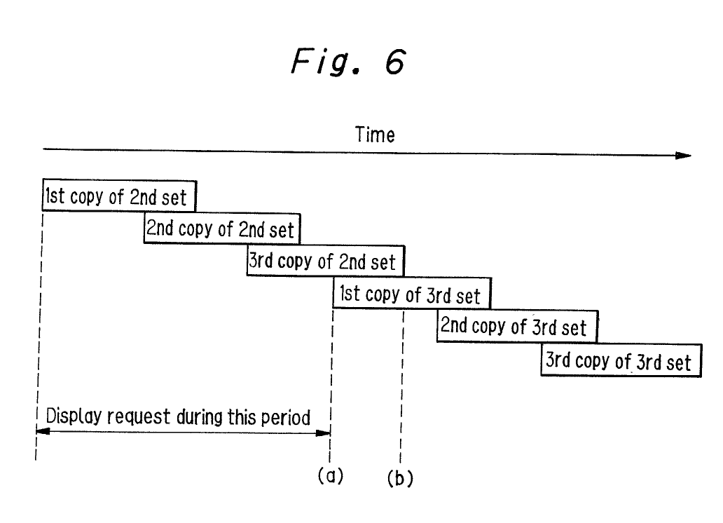

For embodiment 1, time (a) in FIG. 6 is displayed. For embodiment 2, time (b) in FIG. 6 is displayed. In the case of a printer which picks up a sheet of paper only after the pervious sheet is discharged, no problem will occur. However, for a printer which pre-feeds a sheet of paper for printing, the example shown in FIG. 6 needs time for completely discharging the third copy of the second set in order to stop the printing. Therefore, printing for the interrupt job starts later than the first copy of the third set would. For a case where continuous printing can be done even with an interrupt job, time (a) is displayed(embodiment 1). For a case where a new job cannot be started until the current job has been terminated, time (b) is displayed(embodiment 2).

(Embodiment 3)

Instead of displaying the permissible interrupt time as in embodiments 1 and 2, it is also possible to display the finish time at which the requested interrupt job will be completed. This can be performed by the computing portion 105 which has the function of calculating the time at which the requested interrupt job will be ended, instead of computing the interrupt permissible timing or operation termination timing and by the display portion 103 which has the function of displaying the finish time of the interrupt job calculated by computing portion 105. Here, the time at which the interrupt job will be ended is a timing calculated by adding the time required for the requested interrupt job to be performed to the permissible interrupt time determined in embodiment 1 or 2. This time is displayed as the finish time.

(Embodiment 4)

Instead of displaying the processing start time or processing finish time as in embodiments 1, 2 and 3, it is also possible to display the remaining time. This can be done by subtracting the current time from the time determined by embodiment 1, 2 or 3 and displaying the result. Specifically, this can be realized by the computing portion 105 which, instead of computing the interrupt permissible timing, the terminable timing or finish time of the interrupt job, has the function of computing the time length corresponding to one of these and by the display portion 103 which has the function of displaying the time length calculated by computing portion 105.

(Other embodiments)

The above display portion 103 may be configured so that it displays the above time or time length in response to the operation of a key for display request. This can be realized by providing a control key for the display which the user can press to activate the display sequence.

Instead of providing such an extra key, the system may be configured so that the display sequence will start when the user makes an interrupt.

Instead of providing the above display portion 103, a voice generator(sound means) may be provided so as to inform the user of the calculated time or time length via voice.

As has been described heretofore, according to the present invention, since the time at which an interrupt can be made next is displayed, the user is able to know at what time the user's request for printing will be started. Therefore, the user can use their time more efficiently than when they had no idea about the waiting time by making use of the waiting time to perform other tasks.

According to the present invention, since even for a system which needs to terminate the current job for an interrupt job, the time of termination for the next interrupt is displayed, the same effect as above can be obtained.

Next, according to the present invention, since the finish time of an interrupt job can be displayed instead of displaying the start of the interrupt, this configuration allows the user to come and pick up the printouts on time or after the finish of their interrupt job. Accordingly, unnecessary waiting time is cut down so that the user can make use of time by assigning the waiting time to other work.

Further, according to the present invention, since the time length up to the permissible interrupt time, the time of termination or the finish time of the interrupt job is displayed, the user can readily know the specific time length he/she should wait for, without the necessity of calculating the difference from the current time to the display time and hence can make the best, and efficient, use of the waiting time.

Next, according to the present invention, since a dedicated key is provided, display of the time or time length can be given in response to the user's request only when the user operates the key. That is, though continuous display needs a dedicated display device or a display area, provision of this dedicated key makes it possible to give the display only when the user makes a request for an interrupt through the dedicated key. Hence, the display device can be shared resulting in cost reduction.

Moreover, according to the present invention, since the time or time length is displayed in response to the key operation for requesting an interrupt job, no dedicated key is needed, resulting in cost reduction.

Finally, according to the present invention, since the permissible interrupt time or the like can be informed via voice, the system is able to inform the user of the information without affecting the display for control while he/she performs other control operations.

What is claimed is:

1. A multifunctional printing system wherein image information captured through an image information pickup means can be printed as multiple sets of copies by a printing means and which is configured so that the printing operation can be stopped only at intervals from one set of copies to the next or every certain number of printouts, comprising:
a computing means for calculating the time at which an interrupt can be made next, based on the designated number of print sets, the current state of printing, the information as to whether an interrupt is permissible; and
a display means for displaying the permissible interrupt time calculated by the computing means.

2. A multifunctional printing system wherein image information captured through an image information pickup means can be printed as multiple sets of copies by a printing means and which is configured so that the printing operation can be stopped only at intervals from one set of copies to the next or every certain number of printouts and so that the printing operation needs to be stopped in order to allow an interrupt job, comprising:
a computing means for calculating the permissible termination time which allows for an interrupt job, based on the designated number of print sets, the current state of printing, the information as to whether an interrupt is permissible; and
a display means for displaying the permissible termination time calculated by the computing means.

3. The multifunctional printing system according to claim 1, wherein the computing means has the function of calculating the finish time of the requested interrupt job instead of calculating the permissible interrupt time or permissible termination time, and the display means has the function of displaying the finish time of the interrupt job calculated by the computing means.

4. The multifunctional printing system according to claim 2, wherein the computing means has the function of calculating the finish time of the requested interrupt job instead of calculating the permissible interrupt time or permissible termination time, and the display means has the function of displaying the finish time of the interrupt job calculated by the computing means.

5. The multifunctional printing system according to claim 1, wherein the computing means, instead of having the function of calculating the permissible interrupt time, the permissible termination time or the finish time of the interrupt job, has the function of calculating the time length corresponding to any of these, and the display means has the function of displaying the time length calculated by the computing means.

6. The multifunctional printing system according to claim 2, wherein the computing means, instead of having the function of calculating the permissible interrupt time, the permissible termination time or the finish time of the interrupt job, has the function of calculating the time length corresponding to any of these, and the display means has the function of displaying the time length calculated by the computing means.

7. The multifunctional printing system according to any of claims 1 through 6, wherein the display means displays the time or time length in response to the operation of a dedicated key which allows for input of a display request.

8. The multifunctional printing system according to any of claims 1 through 6, wherein the display means displays the time or time length when the key for requesting an interrupt is operated.

9. The multifunctional printing system according to any of claims 1 through 6, wherein a voice generating means for informing the time or the time length via voice is provided instead of the display means.
